(19) United States
(12) Patent Application Publication
(10) Pub. No.: US 2004/0032119 A1
(43) Pub. Date: Feb. 19, 2004

(54) Control of an anti-tip wheel in wheelchairs

(76) Inventors: Sy Tran, Longmont, CO (US); Dennis B. Hooper, Clovis, CA (US); James M. Koerlin, Broomfield, CO (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/447,313

(22) Filed: May 28, 2003

Related U.S. Application Data
(60) Provisional application No. 60/383,951, filed on May 29, 2002.

(51) Int. Cl. F16M 1/00

(52) U.S. Cl. 280/755

(57) ABSTRACT

A wheelchair has a seat frame and a back frame, the wheelchair being configured to tilt the seat frame from an initial position to a tilted position. The wheelchair includes a rear anti-tip wheel pivotally mounted for vertical articulation within a first range of motion. A means for limiting the vertical articulation to a second narrower range of motion in response to tilting of the seat frame is provided.

### RELATED APPLICATIONS

This application claims priority from U.S. Provisional Patent Application Serial No. 60/383,951, filed May 29, 2002, and entitled CONTROL OF AN ANTI-TIP WHEEL IN A WHEELCHAIR HAVING TILT AND RECLINE FUNCTIONS.

### TECHNICAL FIELD

The present invention relates to wheelchairs, and particularly to wheelchairs capable of moving various movable members such as the seat frame and back fame. More particularly, the invention relates to the control of the motion of an anti-tip wheel.

### BACKGROUND OF THE INVENTION

Wheelchairs often have a fixed seat consisting of a seating surface and a back frame. The seating surface is usually either horizontal or slightly tilted back, with the front edge of the seating surface slightly higher than the rear edge of that surface. If the wheelchair user sits in the same position in a wheelchair for a long period of time, pressure is continuously applied to the tissue on the portion of the user's body (buttocks, legs, and/or back) that is bearing the user's weight in that position. Blood circulation to that tissue will be reduced, and ulcers or other problems can result.

To avoid these problems, it is necessary for people sitting in wheelchairs to shift their body weight from time to time. This is often accomplished by tilting the seat portion of the wheelchair backwards so that the user's weight is shifted away from the pressure points on the user's body. Also, the user's weight can be shifted by reclining the back frame.

Wheelchairs are often provided with one or two rear anti-tip wheels that are pivotally mounted for vertical articulation. The purpose of the anti-tip wheels is to limit the amount of backward tipping or pitch of the wheelchair to prevent the wheelchair's tipping completely over backward. Also, the anti-tip wheels are useful in supporting the wheelchair and the wheelchair user when the wheelchair is traversing uneven ground, such as going up and down curbs.

It would be advantageous if there could be developed a wheelchair having improved methods for reclining and/or tilting. Further, it would be advantageous if there could be developed improved methods and apparatus for controlling the movement of anti-tip wheels under various conditions.

### SUMMARY OF THE INVENTION

The above objects as well as other objects not specifically enumerated are achieved by a wheelchair having a seat frame and a back frame, the wheelchair being configured to tilt the seat frame from an initial position to a tilted position. The wheelchair includes a rear anti-tip wheel pivotally mounted for vertical articulation within a first range of motion. A means for limiting the vertical articulation to a second narrower range of motion in response to tilting of the seat frame is provided.

According to this invention there is also provided a wheelchair having a seat frame and a back frame, the wheelchair being adapted to recline the back frame from an initial position to a reclined position. The wheelchair further includes a rear anti-tip wheel pivotally mounted for vertical articulation within a first range of motion. A means for limiting the vertical articulation to a second narrower range of motion in response to reclining of the back frame is also provided.

According to this invention there is also provided a wheelchair having a seat frame and a back frame, the wheelchair being subject to rearward changes in pitch. The wheelchair further includes a rear anti-tip wheel pivotally mounted for vertical articulation within a first range of motion. A sensor for determining the amount of rearward pitch of the wheelchair is provided. Also provided is a means for limiting the vertical articulation to a second narrower range of motion in response to a rearward pitch of the wheelchair exceeding a threshold amount of rearward pitch.

According to this invention there is also provided a wheelchair having a seat frame and a back frame. The wheelchair also includes a rear anti-tip wheel pivotally mounted for vertical articulation within a first range of motion. A sensor is provided for determining the amount of acceleration of the wheelchair. Also provided is a means for limiting the vertical articulation to a second narrower range of motion in response to the acceleration of the wheelchair.

According to this invention there is also provided a wheelchair having a seat frame and a back frame. The wheelchair further includes a rear anti-tip wheel pivotally mounted for vertical articulation within a first range of motion. A pendulum is mounted on the wheelchair for pivotal movement with respect to the wheelchair in response to movement of the wheelchair sensor. Pivotal movement of the pendulum causes a free end of the pendulum move along a path. A pendulum engagement means is positioned to receive the free end of the pendulum when the pendulum swings along the path. Engagement of the free end of the pendulum with the pendulum engagement means limits the vertical articulation of the anti-tip wheel to a second narrower range of motion.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic elevational view of a wheelchair.

FIG. 2 is a schematic view in elevation of a wheelchair anti-tip wheel, with the pawl free of engagement with the ratchet.

FIG. 3 is a detailed view of the ratchet and pawl mechanism of FIG. 2.

FIG. 4 is a schematic view in elevation of the anti-tip wheel of FIG. 1, with the anti-tip wheel near the top of its range of motion and with the pawl engaged with the ratchet.

FIG. 5 is a detailed view of the ratchet and pawl mechanism of FIG. 4.

FIG. 6 is a schematic view in elevation of the anti-tip wheel of FIG. 1, with the anti-tip wheel near the bottom of its range of motion and with the pawl engaged with the ratchet.

FIG. 7 is a detailed view of the ratchet and pawl mechanism of FIG. 6.

FIG. 8 is a schematic view in elevation of a different embodiment of the invention wherein a pendulum is used to limit the motion of the anti-tip wheel.

### DETAILED DESCRIPTION OF THE INVENTION

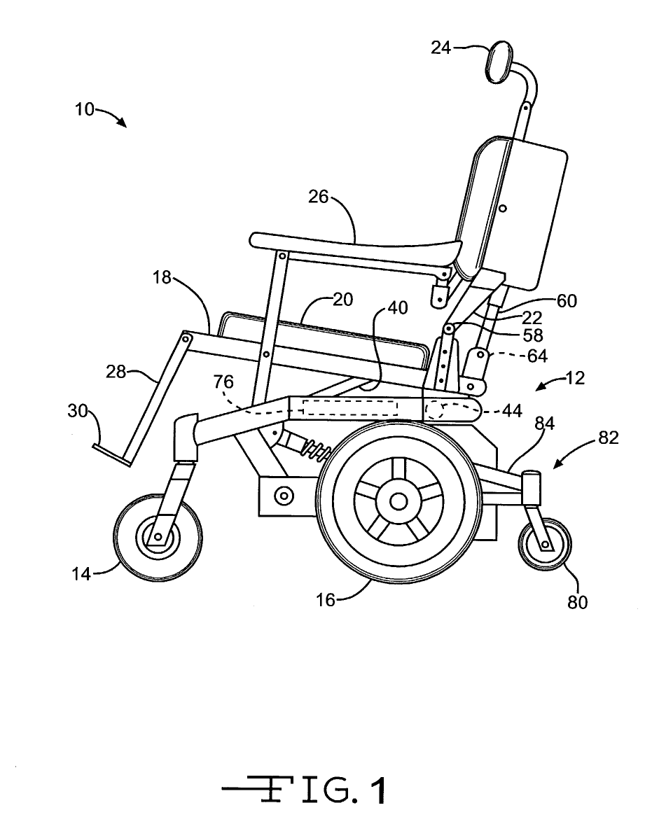

As shown in FIG. 1, a wheelchair indicated generally at 10 is comprised of a wheelchair base 12, which is mounted for movement on front caster wheels 14 and rear drive wheels 16. The wheelchair is preferably provided with a drive motor, not shown, for each of the drive wheels, and a source of power for the drive motors, also not shown. A seat frame 18 supports a seat cushion 20 for the support of the user. A back frame 22 is provided to support the user's body, and a head rest 24 supports the user's head. The user's arms can be supported by armrests 26. Leg rests 28 and footrests 30 are also provided.

The seat frame is mounted for rotation or tilting (in a clockwise direction as shown in FIG. 1) so that the wheelchair user can be tipped back to shift the user's weight for comfort purposes and to relieve pressure from various body parts. The seat frame 18 is pivotally mounted at tilt pivot points. Several mechanisms for tilting the seat, such as a forward moving carriage, are known in the art. Where a carriage is used, a tilt linkage 40 can be provided to hingedly connect the seat frame 18 to the wheelchair base 12. A tilt actuator, not shown, which can be an electrically powered linear actuator, is connected to the base to pull the carriage forward with respect to the base, thereby tilting the seat frame 18. As the carriage slides forward, the tilt linkage 40 pushes up the front of the seat frame 18. The seat frame is provided with a tilt sensor 44 that provides an indication of the amount of tilt or rotation of the seat frame with respect to a frame of reference such as the wheelchair base 12. The tilt sensor 44 can be any suitable means for measuring the tilt. A tilt sensor that can be used for measuring tilt is a potentiometer that provides an electrical signal indicative of the amount of tilt of the seat frame. Alternatively, pulses generated by a reed switch and magnets associated with the actuator can be used to provide an electrical signal indicative of the amount of tilt or recline. Another means for measuring tilt or recline is a quadrature device. It is to be understood that different tilt mechanisms and different tilt sensors can be used with the wheelchair 10.

The wheelchair back frame 22 is mounted for reclining motion about recline pivot points 58. The recline pivot points can be positioned on the seat frame 18 as shown, or can be positioned on the wheelchair base 12 or on the carriage. The reclining movement of the back frame can be driven by any suitable mechanism, such as a recline actuator 60 mounted on a carriage. Operation of the recline actuator rotates or reclines the back frame 22 from an initial position, shown in FIG. 1, to a reclined position. The recline actuator 60 is also used to raise up or unrecline the back frame. Although the initial position for the back frame can be any suitable orientation, it is preferably generally vertical, which is roughly 90 degrees with respect to the wheelchair base 12 or with respect to the surface on which the wheelchair is supported. When the back frame 22 is in a vertical position, the recline actuator 60 is substantially vertically oriented. Recline sensors 64, which can be similar to the tilt sensors 44, can be used to measure the amount of recline of the back frame. The recline sensors could also be mounted in the actuator. It is to be understood that different recline mechanisms and different recline sensors can be used with the wheelchair 10.

A controller 76 is provided to control the various wheelchair seating functions and movement of the various movable frame members, such as the seat frame 18 and back frame 22. The controller can be any device suitable for controlling the various functions of the wheelchair. Preferably the controller 76 is a computer that is capable of receiving input from the various sensors, storing positioning sequences in a storage device, and sending signals to various actuators for moving the various frame members. For example, sensor 44 for sensing the amount of tilt of the seat frame and recline sensor 64 for sensing the amount of recline of the back frame can be linked by connection, not shown, to the controller to enable the controller to have a measure of the movement or position of the seat frame and back frame at any given time. The connection can be a hard wire connection, a radio signal device, or any other suitable device for communicating between the sensors and the controller.

As shown in FIG. 1, the wheelchair is provided with a rear anti-tip wheel 80 that is mounted on a rear anti-tip support assembly 82. It is to be understood that the wheelchair can be provided with either one or two rear anti-tip wheels 80. As shown in FIG. 2, the rear anti-tip support assembly 82 includes a 4-bar hinge mechanism 84 that is comprised of upper arm 86, lower arm 88, rear vertical connector 90 and front vertical connector 92. The four members, 86, 88, 90, and 92, of the 4-bar hinge 84 generally form a parallelogram, with each of the four members being pivotally connected to two of the other members. A tortionelastic spring 93 is provided in the pivotal joint 94 between the front vertical connector 92 and the lower arm 88 to bias the anti-tip wheel 80, urging the anti-tip wheel 80 downward toward the supporting surface. The operation of the torsionelastic spring at a pivotal joint is known in the art, such as, for example, as disclosed in U.S. Pat. No. 6,135,476, to Dickie et al. The rear vertical connector 90 supports the castor housing 96, which in turn supports the caster stem 98 and fork 100 for the anti-tip wheel 80.

The front vertical connector 92 is connected to the upper and lower frame flanges 102 and 104, respectively of the wheelchair frame 12. This connection can be by any suitable means, such as with bolts 106 and 108, respectively. A pivotal member, such as ratchet arm 110, is attached to the lower frame flange 104. Preferably, the ratchet arm 110 is mounted for rotation or pivoting about the lower bolt 108. Other pivot points can also be used. A spring 112 can be provided to bias the pivoting of the ratchet arm 110 so that the distal end 114 of the ratchet arm 110 is biased upward. Other biasing means, including springs positioned in different locations from that of spring 112 can be used.

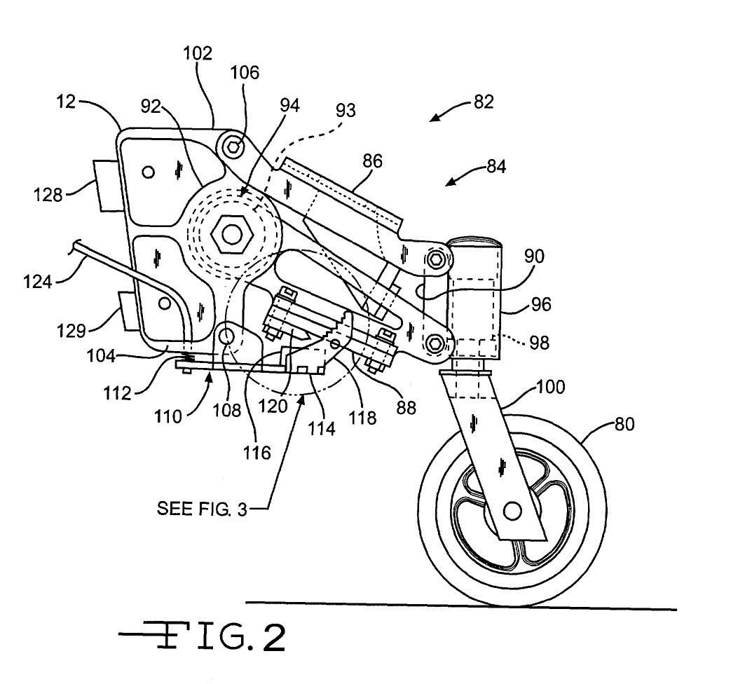

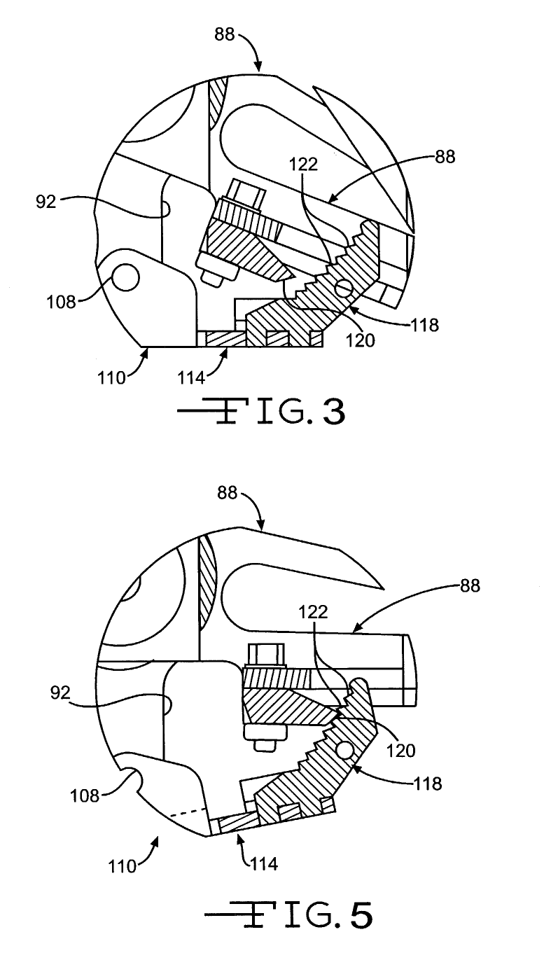

As shown in FIGS. 2 and 3, a slider block 116 mounted on the distal end 114 of the ratchet arm 110 supports a ratchet 118. The slider block 116 allows the ratchet 118 to be adjusted for optimum alignment with a pawl 120 that is mounted on the lower arm 88 of the 4-bar hinge 84. It is to be understood that the pawl 120 could also be mounted for adjustment with respect to the lower arm 88 for alignment with the ratchet 118. The ratchet is provided with a plurality of notches or grooves 122, and engagement of the pawl 120 in any of the grooves 122 limits or prevents movement of the lower arm 88 with respect to the ratchet 118. This limiting or prevention of movement of the lower arm 88 with respect to the ratchet 118 acts to prohibit movement of the lower arm 88 with respect to the lower frame flange 104 and wheelchair frame 12, thereby prohibiting any further movement of the anti-tip wheel 80 with respect to the wheelchair frame 12 and hence the support surface.

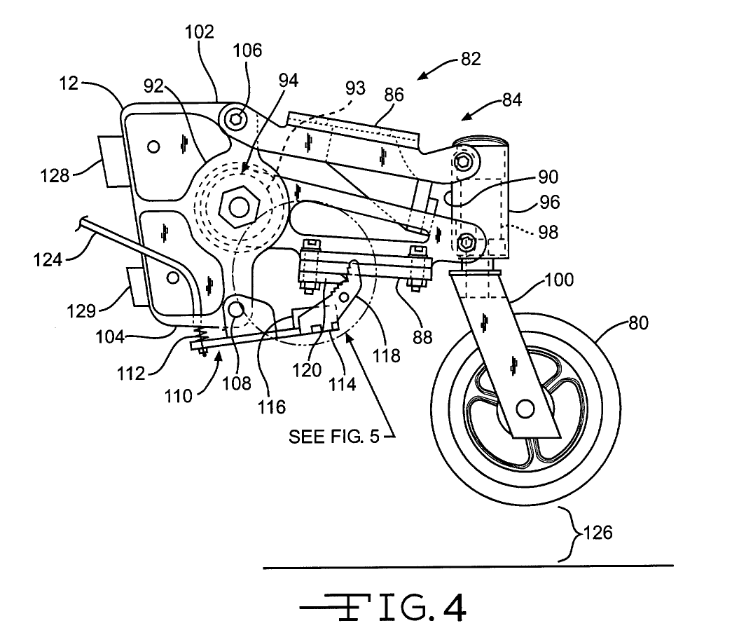

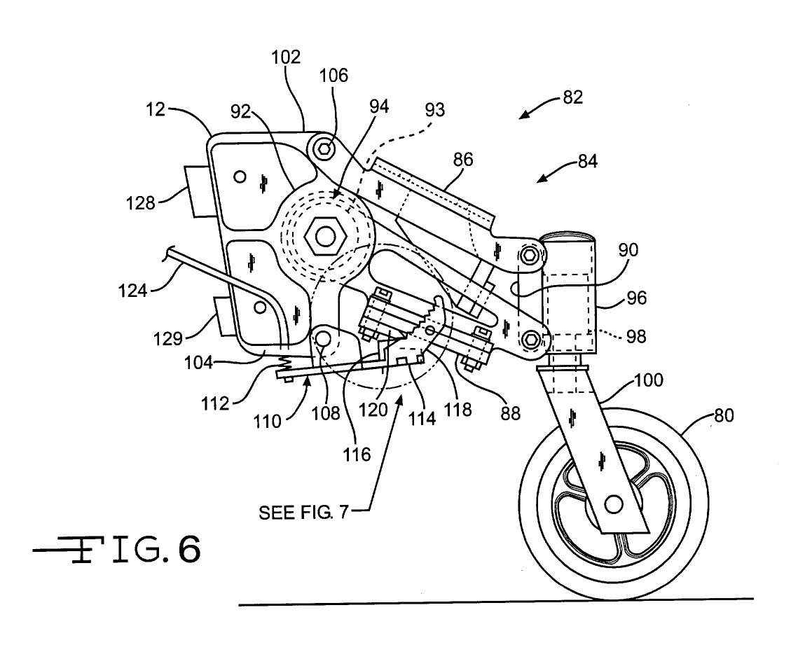

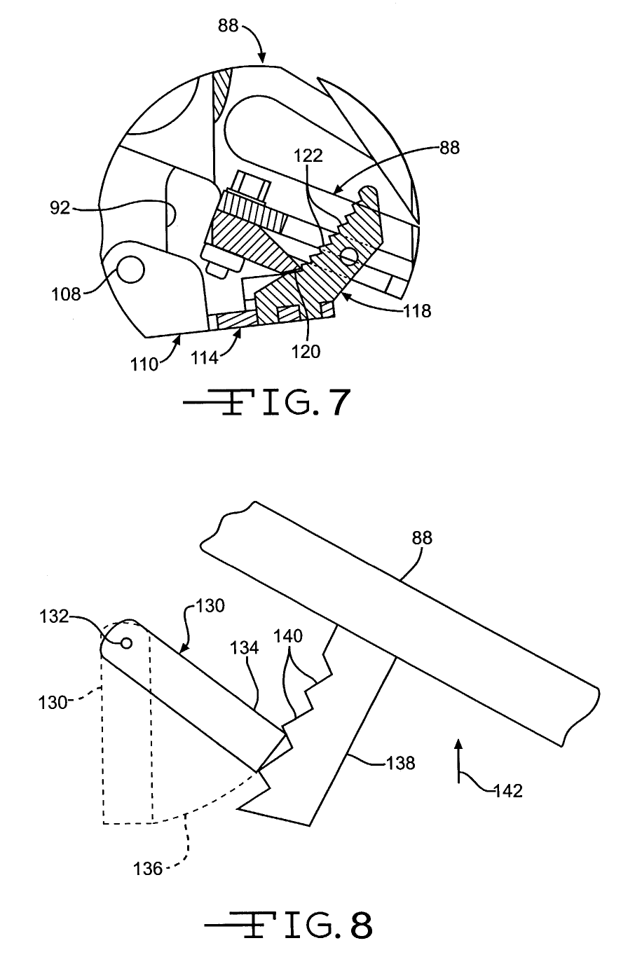

The anti-tip wheel 80 is shown in FIGS. 2 and 6 as being on the support surface, with the 4-bar hinge 84 in a relatively downwardly angled position with respect to the wheelchair frame 12. In contrast, in FIG. 4, the anti-tip wheel is raised above the support surface. In FIGS. 4, 5, 6, and 7 the pawl 120 is shown as being engaged with the ratchet 118. The engaged configuration of the pawl with the ratchet is accomplished by articulation or pivoting of the ratchet arm 110. As shown in FIGS. 2, 4 and 6, the pivoting of the ratchet arm 110 is controlled by an activation cable 124. The activation cable pulls the ratchet arm, thereby pivoting it (in a clockwise direction as shown in FIG. 2) and causing the pawl 120 to become disengaged from the ratchet 118. The action of the spring 112 biasing the ratchet arm 110 away from the lower frame flange 104 provides a fail-safe limiting of the vertical articulation of the anti-tip wheel 80, i.e., absent action by the activation cable, the range of motion of the anti-tip wheel 80 will be limited. The activation cable 124, when activated, overcomes the force of the spring 112. The activation cable can be operated manually. In the alternative, the activation cable can be configured for purely mechanical operation, wherein the tilting and/or reclining of the wheelchair mechanically tensions the cable to engage the ratchet and pawl. The cable can also be configured to be operated with a motor, with the motor being operable upon voice commands, or upon signals from the controller 76 in response to signals from various sensors. Other types of activation means could be used for controlling the position of the ratchet arm and hence the engagement of the ratchet with the pawl. Examples include magnetic activators, pneumatic activators and different types of mechanical linkages.

The anti-tip support assembly 82, including the 4-bar hinge 84 and anti-tip wheel 80 are pivotally mounted about the pivotal joint 94 for vertical articulation within a first range of motion, indicated by bracket 126 in FIG. 4. One useful purpose for mounting the anti-tip wheel for articulation in a vertical range of motion is that the wheelchair can be supported while the wheelchair is traversing uneven ground, or traversing a curb or step. When the pawl 120 is not engaged with the ratchet 118, the rear anti-tip support assembly 82 and the anti-tip wheel 80 are free to move vertically within the first range of motion. When the pawl 120 becomes engaged with the ratchet 118, however, the pawl can only move within the limited range within one of the grooves 122, and in fact the pawl will most likely become stationary with respect to the ratchet. This will have the effect of limiting or stopping any further vertical articulation of the rear anti-tip assembly 82 and the anti-tip wheel 80. Thus, the vertical articulation of the anti-tip wheel 80 is limited to a second narrower range of motion, or to a state of zero relative motion. It is to be understood that this second narrower range of motion can be zero motion, i.e., with the pawl being fully engaged with the ratchet and fixed with respect to the ratchet.

There are several situations where the it may be necessary or desirable to limit the vertical articulation of the anti-tip wheel 80. One such situation is where the wheelchair is subjected to rearward pitch, which can result from rapid acceleration of the wheelchair or from deceleration of the wheelchair while the wheelchair is moving in a reverse direction. Another movement or action where it would be desirable to limit the vertical articulation of the anti-tip wheel 80 is when the seat frame is tilted or when the seat back is reclined. In either case, the center of gravity of the combined wheelchair and wheelchair user is moved rearward. Yet another example of a situation where the vertical articulation of the anti-tip wheel 80 should be limited is when the wheelchair is positioned on an incline, which would possibly cause the wheelchair to experience rearward pitch. In all of these examples the limiting of the vertical articulation of the wheelchair acts to provide stability to the wheelchair, thereby giving the wheelchair user more confidence and a more secure feeling.

In a particular embodiment of the invention, a threshold is established for 1) the amount of pitch, 2) the degree of tilt, 3) the degree of recline, and/or 4) the angle of incline, respectively, wherein when the threshold is exceeded, the anti-tip wheel 80 becomes fixed with respect to the wheelchair frame 12. In another embodiment of the invention, a motion sensor 128 (shown in FIGS. 2, 4 and 6) connected to the wheelchair frame 12 provides a signal to the activation means when the wheelchair experiences rearward pitch at a rate exceeding a predetermined rate. In this embodiment, the rearward pitch can occur without locking the anti-tip wheel 80 as long as the rate of change in pitch is below a threshold level. When the rearward pitch changes too fast, the activation means will be operated to block further vertical articulation of the anti-tip wheel 80.

Although a ratchet and pawl mechanism for limiting the articulation of anti-tip wheel 80 is illustrated in the drawings, other means for limiting the vertical articulation of the anti-tip wheel 80 can be used. For example, a brake mechanism can be provided within or connected to the pivotal joint 94. Upon activation, the brake mechanism would limit the vertical articulation of the anti-tip wheel 80 to a limited range, or to a state of zero movement. A suitable brake mechanism would be a Mec-lock brake, which includes a tube having a rod positioned through the tube, and a wrap spring around the tube. A magnetic system which can lock or limit the relative movement of the anti-tip wheel 80 into a narrower range of movement or to a state of zero movement can also be used. Other movement limiting mechanisms are possible.

An additional embodiment of the invention involves a sensor 129 (shown in FIGS. 2, 4 and 6) attached to the wheelchair for determining the amount of acceleration of the wheelchair. In response to the sensed acceleration of the wheelchair, the means for limiting the vertical articulation to a second narrower range of motion is activated. The sensor can be any mechanism suitable for measuring the acceleration of the wheelchair, such as an accelerometer.

In yet another embodiment of the invention, shown in FIG. 8, a pendulum 130 is mounted on the wheelchair for pivotal movement with respect to the wheelchair in response to movement of the wheelchair. As the pendulum 130 pivots about its pivot point 132, a free end 134 of the pendulum 130 moves along a path indicated at 136. The pendulum 130 is shown in solid lines as being moved along the path 136 by acceleration of the wheelchair. The position of the pendulum in a situation where there is no acceleration is indicated in phantom lines. When acceleration of the wheelchair, or positioning of the wheelchair on an inclined surface cause the pendulum 130 to swing along the path 136 beyond a threshold amount, the free end 134 of the pendulum connects with a pendulum engagement means, which can be in the shape of a ratchet 138, or any other shape suitable for engaging the distal end 134 of the pendulum 130. The ratchet 138 is provided with notches or grooves 140, and is mounted on the lower arm 88 of the 4-bar hinge mechanism 84. Under normal operation of the anti-tip wheel 80, vertical articulation of the anti-tip wheel requires a raising up of the lower arm 88 and the ratchet 138, as indicated by the directional 1o arrow 142. Engagement of the free end 134 of the pendulum 130 with the pendulum engagement means or ratchet 138 prevents further upward movement of the ratchet 138 and hence prevents further upward movement of the lower arm 88. Therefore, the vertical articulation of the anti-tip wheel is limited by the engagement of the pendulum 130 with the ratchet 138 to a second narrower range of motion, which can also be a condition of zero relative motion.

The principle and mode of operation of this invention have been described in its preferred embodiments. However, it should be noted that this invention may be practiced otherwise than as specifically illustrated and described without departing from its scope.

What is claimed is:

1. A wheelchair having a seat frame and a back frame, the wheelchair being configured to tilt the seat frame from an initial position to a tilted position, the wheelchair further comprising:
a rear anti-tip wheel pivotally mounted for vertical articulation within a first range of motion; and
means for limiting the vertical articulation to a second narrower range of motion in response to tilting of the seat frame.

2. The wheelchair of claim 1 where the second range of motion is zero, with the anti-tip wheel fixed with respect to the wheelchair.

3. The wheelchair of claim 1 where the means for limiting the vertical articulation is a ratchet and pawl.

4. The wheelchair of claim 3 in which the ratchet and pawl are biased toward an engaged configuration.

5. The wheelchair of claim 3 where one of the ratchet and the pawl is mounted on a pivotable member.

6. The wheelchair of claim 5 where the pivotable member is biased toward an engaged configuration for the ratchet and pawl.

7. The wheelchair of claim 5 including a cable for controlling the pivoting of the pivotal member.

8. The wheelchair of claim 1 where the means for limiting the vertical articulation of the anti-tip wheel is a brake mounted to control the pivoting of the pivotally mounted anti-tip wheel.

9. The wheelchair of claim 1 in which a threshold level of tilt is established, and the means for limiting the vertical articulation to the second range of motion is configured to be activated when the threshold level of tilt is reached.

10. A wheelchair having a seat frame and a back frame, the wheelchair being adapted to recline the back frame from an initial position to a reclined position, the wheelchair further comprising:
a rear anti-tip wheel pivotally mounted for vertical articulation within a first range of motion; and
means for limiting the vertical articulation to a second narrower range of motion in response to reclining of the back frame.

11. The wheelchair of claim 10 where the second range of motion is zero, with the anti-tip wheel fixed with respect to the wheelchair.

12. The wheelchair of claim 10 where the means for limiting the vertical articulation is a ratchet and pawl.

13. The wheelchair of claim 12 in which the ratchet and pawl are biased toward an engaged configuration.

14. The wheelchair of claim 12 where one of the ratchet and the pawl is mounted on a pivotable member.

15. The wheelchair of claim 14 where the pivotable member is biased toward an engaged configuration for the ratchet and pawl.

16. The wheelchair of claim 14 including a cable for controlling the pivoting of the pivotal member.

17. The wheelchair of claim 10 where the means for limiting the vertical articulation of the anti-tip wheel is a brake mounted to control the pivoting of the pivotally mounted anti-tip wheel.

18. The wheelchair of claim 10 in which a threshold level of recline is established, and the means for limiting the vertical articulation to the second range of motion is configured to be activated when the threshold level of recline is reached.

19. A wheelchair having a seat frame and a back frame, the wheelchair being subject to rearward changes in pitch, the wheelchair further comprising:
a rear anti-tip wheel pivotally mounted for vertical articulation within a first range of motion;
a sensor for determining the amount of rearward pitch of the wheelchair; and
means for limiting the vertical articulation to a second narrower range of motion in response to a rearward pitch of the wheelchair exceeding a threshold amount of rearward pitch.

20. The wheelchair of claim 19 where the second range of motion is zero, with the anti-tip wheel fixed with respect to the wheelchair.

21. The wheelchair of claim 19 where the means for limiting the vertical articulation is a ratchet and pawl.

22. The wheelchair of claim 21 in which the ratchet and pawl are biased toward an engaged configuration.

23. The wheelchair of claim 21 where one of the ratchet and the pawl is mounted on a pivotable member.

24. The wheelchair of claim 23 where the pivotable member is biased toward an engaged configuration for the ratchet and pawl.

25. The wheelchair of claim 23 including a cable for controlling the pivoting of the pivotal member.

26. The wheelchair of claim 19 where the means for limiting the vertical articulation of the anti-tip wheel is a brake mounted to control the pivoting of the pivotally mounted anti-tip wheel.

27. A wheelchair having a seat frame and a back frame, the wheelchair further comprising:
a rear anti-tip wheel pivotally mounted for vertical articulation within a first range of motion; and
a sensor for determining the amount of acceleration of the wheelchair;
means for limiting the vertical articulation to a second narrower range of motion in response to the acceleration of the wheelchair.

28. The wheelchair of claim 27 in which the means for limiting the vertical articulation of the anti-tip wheel is subject to activation when the acceleration of the wheelchair exceeds a threshold amount of acceleration.

29. A wheelchair having a seat frame and a back frame, the wheelchair further comprising:
a rear anti-tip wheel pivotally mounted for vertical articulation within a first range of motion; and
a pendulum mounted on the wheelchair for pivotal movement with respect to the wheelchair in response to movement of the wheelchair sensor, the pivotal movement of the pendulum causing a free end of the pendulum move along a path; and
a pendulum engagement means for receiving the free end of the pendulum;
wherein engagement of the free end of the pendulum with the pendulum engagement means limits the vertical articulation of the anti-tip wheel to a second narrower range of motion.
